(19) United States
(12) Patent Application Publication
(10) Pub. No.: US 2025/0172927 A1
(43) Pub. Date: May 29, 2025

(54) INFORMATION PROCESSING METHOD AND INFORMATION PROCESSING DEVICE

(71) Applicant: Panasonic Intellectual Property Management Co., Ltd., Osaka (JP)

(72) Inventors: Takuya MATSUMOTO, Hyogo (JP); Hiroshi AMANO, Osaka (JP); Tomoya HIRATA, Osaka (JP)

(21) Appl. No.: 18/839,985

(22) PCT Filed: Feb. 27, 2023
(86) PCT No.: PCT/JP2023/007171

§ 371 Date: Aug. 20, 2024

(30) Foreign Application Priority Data
Mar. 14, 2022 (JP) 2022-039709

(51) Int. Cl. G05B 19/418; G06Q 10/0631

(52) U.S. Cl. CPC G05B 19/41865; G06Q 10/06311

(57) ABSTRACT

The information processing method includes: obtaining items of priority data each representing a priority for a combination of a unit of equipment among units of equipment and a stoppage factor, the priority being for recovery work for equipment that has stopped among the units of equipment; estimating, for each item of the priority data, an equipment operating rate of overseen equipment among the units of equipment, the overseen equipment being equipment that a worker who performs the recovery work is in charge of; selecting, from among the items of priority data, priority data for which the equipment operating rate is greater than or equal to a threshold value; and outputting the selected priority data.

### CROSS-REFERENCE OF RELATED APPLICATIONS

This application is the U.S. National Phase under 35 U.S.C. § 371 of International Patent Application No. PCT/JP2023/007171, filed on Feb. 27, 2023, which in turn claims the benefit of Japanese Patent Application No. 2022-039709, filed on Mar. 14, 2022, the entire disclosure of which applications are incorporated by reference herein.

### TECHNICAL FIELD

The present disclosure relates to an information processing method and an information processing device.

### BACKGROUND ART

Patent Literature (PTL) 1 discloses a work management support device intended to facilitate work management. In the work management support device of PTL 1, work priorities are set, and work assignments to workers are set based on work priorities and worker information.

### CITATION LIST

### Patent Literature

[PTL 1] Japanese Unexamined Patent Application Publication No. 2000-214905

### SUMMARY OF INVENTION

### Technical Problem

However, with the work management support device described in the Background Art, there may be cases where an appropriate work priority cannot be set, and thus there may be cases where this does not lead to improved productivity.

Accordingly, the present disclosure provides an information processing method and the like that can support the improvement of productivity.

### Solution to Problem

An information processing method according to one aspect of the present disclosure includes: obtaining items of priority data each representing a priority for a combination of a unit of equipment among units of equipment and a stoppage factor, the priority being for recovery work for equipment that has stopped among the units of equipment; estimating, for each item of the priority data, an equipment operating rate of overseen equipment among the units of equipment, the overseen equipment being equipment that a worker who performs the recovery work is in charge of; selecting, from among the items of priority data, priority data for which the equipment operating rate is greater than or equal to a threshold value; and outputting the priority data selected.

An information processing device according to one aspect of the present disclosure includes: an obtainer that obtains items of priority data each representing a priority for a combination of a unit of equipment among units of equipment and a stoppage factor, the priority being for recovery work for equipment that has stopped among the units of equipment; an estimator that estimates, for each item of the priority data, an equipment operating rate of overseen equipment among the units of equipment, the overseen equipment being equipment that a worker who performs the recovery work is in charge of; a selector that selects, from among the items of priority data, priority data for which the equipment operating rate is greater than or equal to a threshold value; and an outputter that outputs the priority data selected.

Moreover, one aspect of the present disclosure can be realized as a program for causing a computer to execute the information processing method described above. Alternatively, one aspect of the present disclosure can be realized as a non-transitory computer-readable recording medium having such a program recorded thereon.

### Advantageous Effects of Invention

According to the present disclosure, it is possible to support the improvement of productivity.

### BRIEF DESCRIPTION OF DRAWINGS

FIG. 1 illustrates a configuration of a factory in which an information processing system according to an embodiment of the present disclosure is applied.

FIG. 2 is a block diagram illustrating the configuration of an information processing system according to an embodiment of the present disclosure.

FIG. 3 is a block diagram illustrating the configuration of an information processing device according to an embodiment of the present disclosure.

FIG. 4 illustrates one example of operating performance data.

FIG. 5 illustrates one example of work performance data.

FIG. 6 illustrates one example of worker assignment data.

FIG. 7 illustrates one example of priority data.

FIG. 8 illustrates one example of a priority setting method.

FIG. 9 illustrates the relationship between priority and one example of average work time per stoppage factor.

FIG. 10 illustrates the relationship between priority and one example of average time between failures per unit of equipment.

FIG. 11 is a sequence diagram illustrating a process for accumulating data (learning phase) by an information processing system according to an embodiment of the present disclosure.

FIG. 12 is a sequence diagram illustrating a process for estimating a distribution (learning phase) by an information processing system according to an embodiment of the present disclosure.

FIG. 13 is a sequence diagram illustrating a process for determining optimal priority data and optimal worker assignment data (usage phase) by an information processing system according to an embodiment of the present disclosure.

FIG. 14 is a flowchart illustrating a process for estimating a work time distribution by an information processing system according to an embodiment of the present disclosure.

FIG. 15 is a flowchart illustrating a process for estimating an operating time distribution by an information processing system according to an embodiment of the present disclosure.

FIG. 16 is a flowchart illustrating worker assignment generation processing performed by an information processing system according to an embodiment of the present disclosure.

FIG. 17 is a flowchart illustrating processing for estimating an overseen-equipment operating rate performed by an information processing system according to an embodiment of the present disclosure.

FIG. 18 is a flowchart illustrating processing for estimating total downtime and total operating time by an information processing system according to an embodiment of the present disclosure.

FIG. 19 illustrates one example of virtual equipment information.

FIG. 20 illustrates eight units of equipment for which two workers are in charge of recovery work.

FIG. 21 illustrates the average time between failures and average work time for the eight units of equipment illustrated in FIG. 20.

FIG. 22A illustrates the first worker assignment candidates in the example illustrated in FIG. 20.

FIG. 22B illustrates the second worker assignment candidates in the example illustrated in FIG. 20.

FIG. 23 illustrates the estimated equipment operating rate results for the example illustrated in FIG. 20.

### DESCRIPTION OF EMBODIMENTS

### Overview of Present Disclosure

An information processing method according to one aspect of the present disclosure includes: obtaining items of priority data each representing a priority for a combination of a unit of equipment among units of equipment and a stoppage factor, the priority being for recovery work for equipment that has stopped among the units of equipment; estimating, for each item of the priority data, an equipment operating rate of overseen equipment among the units of equipment, the overseen equipment being equipment that a worker who performs the recovery work is in charge of; selecting, from among the items of priority data, priority data for which the equipment operating rate is greater than or equal to a threshold value; and outputting the priority data selected.

This makes it possible to select suitable priority data from among a plurality of items of priority data, since the equipment operating rate is estimated for each item of priority data. Therefore, for example, it becomes possible to notify workers of recovery work based on suitable priority data so as to further improve productivity. The information processing method according to the present embodiment can therefore support the improvement of productivity.

For example, in the estimating, the equipment operating rate may be estimated as a ratio of (i) a sum of operating times of each unit of the overseen equipment to (ii) a sum of the operating times of each unit of the overseen equipment and downtimes of each unit of the overseen equipment.

This makes it possible to estimate the equipment operating rate with high accuracy.

For example, in the selecting, the item of priority data for which the equipment operating rate is the highest may be selected.

This makes it possible to select optimal priority data, thereby enabling more effective support for the improvement of productivity.

For example, the information processing method according to one aspect of the present disclosure may further include generating worker assignment data representing assignments of workers to the overseen equipment the workers are in charge of among the units of equipment. The estimating and the selecting may be performed for each item of the worker assignment data and for each of the workers. The information processing method according to one aspect of the present disclosure may further include estimating an overall operating rate for each item of the worker assignment data based on the priority data and the equipment operating rate of the overseen equipment for each of the workers, the overall operating rate being an equipment operating rate for the units of equipment as a whole. In the outputting, the worker assignment data for which the overall operating rate is greater than or equal to a threshold value and the priority data for each of the workers may be output.

This makes it possible to select suitable worker assignment data, thereby enabling appropriate assignment of overseen equipment to improve productivity. Therefore, the information processing method according to the present embodiment can support the improvement of productivity.

For example, the information processing method according to one aspect of the present disclosure may further include obtaining worker assignment conditions including a total number of the units of equipment and a total number of the workers. In the generating, the worker assignment data may be generated based on the worker assignment conditions.

This makes it possible to create worker assignment candidates suited to the actual circumstances of the production system by obtaining worker assignment conditions to be satisfied. By not creating worker assignment candidates that clearly do not contribute to improving productivity, it is possible to reduce the amount of processing required for determining the worker assignment data.

For example, in the outputting, the worker assignment data for which the overall operating rate is the highest and the priority data for each of the workers may be output.

This makes it possible to select optimal worker assignment data, thereby enabling more effective support for the improvement of productivity.

For example, the information processing method according to one aspect of the present disclosure may further include obtaining operating performance data representing operating statuses of the equipment and work performance data representing work times of the workers; and estimating, based on the operating performance data and the work performance data, operating time distributions for each unit of the equipment and work time distributions for each of the workers. In the estimating of the equipment operating rate, the equipment operating rate may be estimated for each item of the worker assignment data and for each of the workers, using the operating time distributions and the work time distributions.

This makes it possible to increase the accuracy of the estimated equipment operating rate since the work time distribution and operating time distribution estimated by machine learning or the like are used. By selecting priority data and worker assignment data based on an equipment operating rate with high accuracy, it is possible to provide more effective support for the improvement of productivity.

An information processing device according to one aspect of the present disclosure includes: an obtainer that obtains items of priority data each representing a priority for a combination of a unit of equipment among units of equipment and a stoppage factor, the priority being for recovery work for equipment that has stopped among the units of equipment; an estimator that estimates, for each item of the priority data, an equipment operating rate of overseen equipment among the units of equipment, the overseen equipment being equipment that a worker who performs the recovery work is in charge of; a selector that selects, from among the items of priority data, priority data for which the equipment operating rate is greater than or equal to a threshold value; and an outputter that outputs the priority data selected.

This makes it possible to support the improvement of productivity in the same manner as the above-described information processing method.

Hereinafter, one or more embodiments will be described in detail with reference to the drawings.

Each embodiment described below shows a general or specific example. The numerical values, shapes, materials, elements, the arrangement and connection of the elements, steps, order of the steps etc., indicated in the following embodiments are mere examples, and therefore do not intend to limit the present disclosure. Therefore, among elements in the following embodiments, those not recited in any of the independent claims are described as optional elements.

The figures are schematic illustrations and are not necessarily precise depictions. Accordingly, the figures are not necessarily to scale. Moreover, in the figures, the same reference signs are used for elements that are essentially the same. Accordingly, duplicate description is omitted or simplified.

### Embodiment

1. Example of Factory in which Information Processing System is Applied

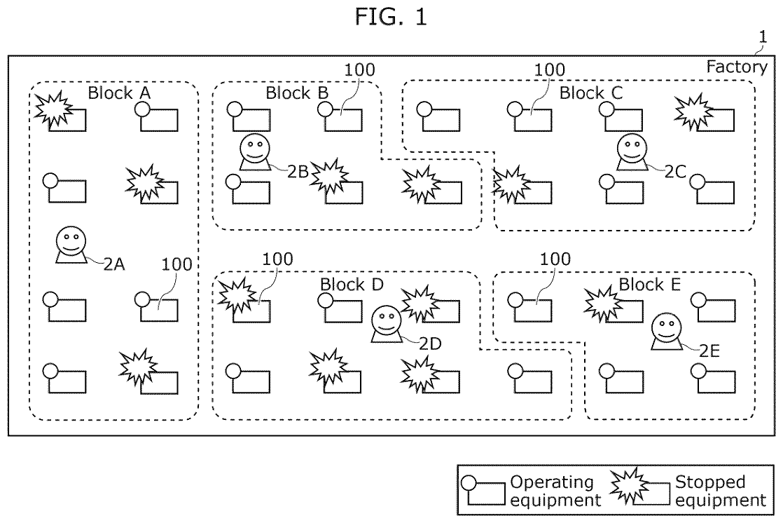

First, an example of a factory in which an information processing system according to an embodiment of the present disclosure is applied will be described with reference to FIG. 1. FIG. 1 is a plan view illustrating a configuration of factory 1 in which an information processing system according to the present embodiment is applied.

As illustrated in FIG. 1, a plurality of units of manufacturing equipment 100 are arranged in factory 1. Each of the plurality of units of manufacturing equipment 100 executes one process among a plurality of processes for manufacturing a product. Manufacturing equipment 100 is, for example, a component mounting machine, a processing device, or an assembly device, but manufacturing equipment 100 is not particularly limited. Manufacturing equipment 100 produces components by executing the process, and outputs the produced components.

Components are, for example, parts included in the final product (that is, the product), or an unfinished part in the middle of the manufacturing of the final product, but components are not limited to these examples. Components are items used to produce parts or unfinished parts, and do not need to be included in the final product. Manufacturing equipment 100 may be any equipment involved in the manufacturing of products, and may be an inspection device that inspects components, unfinished parts, or products.

In the present specification, the terms “produce” or “production” or any other variation thereof means not only creating the final product, but also includes processing, assembly, and inspection of components (parts or unfinished parts). For example, a component produced by manufacturing equipment 100 is a component output after manufacturing equipment 100 executes a process (processing, assembly, inspection, etc.) assigned to manufacturing equipment 100. Moreover, “manufacturing” is an example of production, and in the case where the final product is an industrial product, “manufacturing” is used with the same meaning as “production”.

A plurality of workers 2A to 2E are engaged in work in factory 1. In the example illustrated in FIG. 1, factory 1 is divided into 5 blocks A to E, and a worker is assigned to each block. For example, worker 2A is in charge of the eight units of manufacturing equipment 100 arranged in block A, and performs recovery work when these units of manufacturing equipment 100 stop.

There is a possibility that two or more of the eight units of manufacturing equipment 100 that worker 2A is in charge of stop. Stoppages may occur in each unit of manufacturing equipment 100 due to any number of factors (stoppage factors). Worker 2A performs recovery work on the two or more units of manufacturing equipment 100 that are stopped in an order of predetermined priority. Since the order of performing recovery work leads to improved productivity if appropriate, determining the priority appropriately is desired.

In view of this, the information processing system according to the present embodiment determines and outputs appropriate priority data for each worker. Priority data is data representing a priority for each combination of manufacturing equipment 100 and stoppage factor. The priority is a numerical value set for each combination of manufacturing equipment 100 and stoppage factor. Recovery work is performed in order from highest priority (largest numerical value).

Generally, for each unit of manufacturing equipment 100, the work time required for recovery work differs depending on the stoppage factor. The average time between failures differs for each unit of manufacturing equipment 100 as well. Therefore, for example, if one worker is primarily responsible for manufacturing equipment 100 with a short average time between failures, the number of units of manufacturing equipment 100 that are stopped increases and productivity decreases. Therefore, among the plurality of units of manufacturing equipment 100, which unit of manufacturing equipment's recovery work is to be assigned to which worker, i.e., the worker-to-equipment assignment (combination) indicating the correspondence between workers and the equipment they are in charge of, becomes important for improving productivity.

In view of this, the information system according to the present embodiment further determines and outputs appropriate worker assignment data. Worker assignment data is data representing the assignment of the plurality of workers 2A to 2E to the equipment they are in charge of among the plurality of units of manufacturing equipment 100.

### 2. Information Processing System Configuration

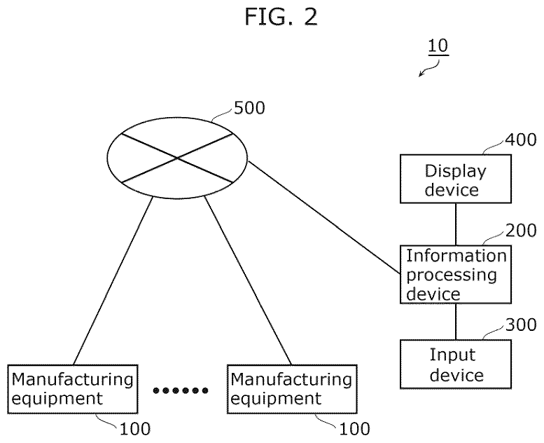

Hereinafter, a specific configuration of the information processing system according to the present embodiment will be described with reference to FIG. 2.

FIG. 2 is a block diagram illustrating the configuration of information processing system 10 according to the present embodiment.

As illustrated in FIG. 2, information processing system 10 includes a plurality of units of manufacturing equipment 100, information processing device 200, input device 300, and display device 400. The plurality of units of manufacturing equipment 100, information processing device 200, input device 300, and display device 400 are communicably connected to each other via network 500. The communication between each device may be wired or wireless communication.

The plurality of units of manufacturing equipment 100 execute one process among a plurality of processes for manufacturing a product, as described above. Each unit of manufacturing equipment 100 includes one or more sensors and an inputter for detecting the operating status of manufacturing equipment 100 and the work status of recovery work. The operating status includes the equipment ID of manufacturing equipment 100, a stoppage timepoint, a stoppage factor, and an operation timepoint. The work status includes the equipment ID of manufacturing equipment 100, a worker ID, a work start timepoint, and a recovery timepoint (operation timepoint). The inputter is, for example, a touch panel or a physical button. The work start timepoint can be obtained by the worker inputting that recovery work has started via the inputter.

Information processing device 200 selects and outputs appropriate priority data from among a plurality of items of priority data. More specifically, information processing device 200 estimates an equipment operating rate for each item of priority data, and selects and outputs priority data for which the estimated equipment operating rate (overseen-equipment operating rate) is greater than or equal to a threshold value. The threshold value is a predetermined value, but is not limited thereto. The threshold value may be an equipment operating rate set in one of the plurality of items of priority data. Stated differently, information processing device 200 may compare the equipment operating rates set for each item of priority data and select priority data with a higher equipment operating rate than others. More specifically, information processing device 200 selects and outputs the priority data with the highest equipment operating rate as optimal priority data. The selection of priority data is performed per worker.

Information processing device 200 determines and outputs worker assignment data based on the priority data selected per worker. More specifically, information processing device 200 estimates an overall operating rate, which is the equipment operating rate of the entirety of the plurality of units of manufacturing equipment 100 as a whole, and determines and outputs worker assignment data for which the estimated overall operating rate is greater than or equal to a threshold value. The threshold value is a predetermined value, but is not limited thereto. The threshold value may be an overall operating rate estimated for one of the plurality of items of worker assignment data. Stated differently, information processing device 200 may compare the overall operating rates estimated for each item of worker assignment data and select worker assignment data with a higher overall operating rate than others. More specifically, information processing device 200 determines and outputs the worker assignment data with the highest overall operating rate as optimal worker assignment data.

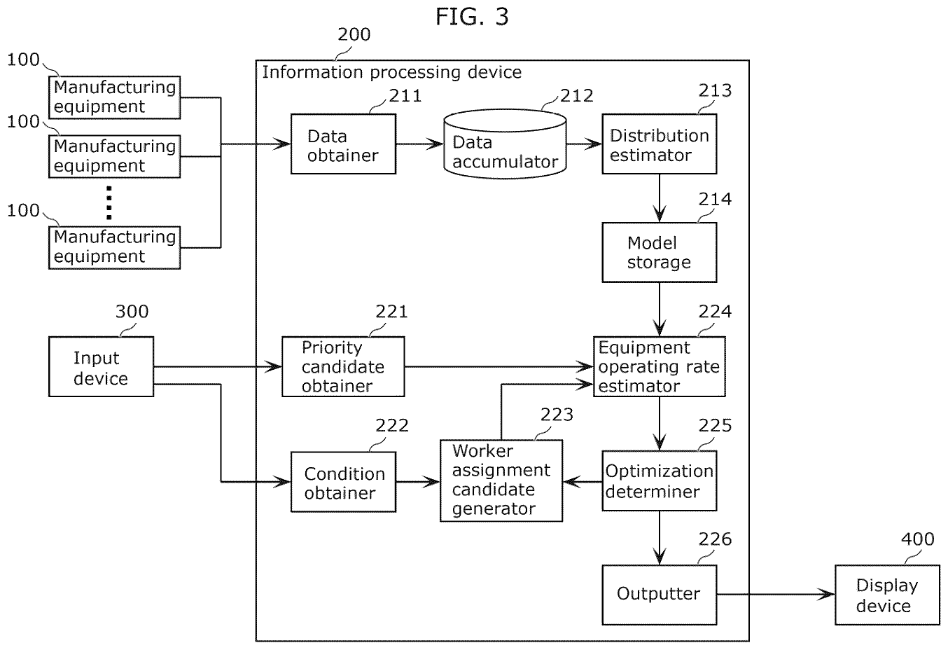

Information processing device 200 includes one or more computer devices that include a processor and memory. The processor reads and executes a program stored in the memory to execute predetermined processing. Note that at least a part of the processing executed by information processing device 200 may be executed by a dedicated circuit. The detailed functional configuration of information processing device 200 will be described later with reference to FIG. 3.

Input device 300 is a device that accepts predetermined inputs to information processing device 200. Input device 300 is, for example, a mouse, a keyboard, a microphone, a touch panel, etc.

Input device 300 accepts, for example, instructions to start processing and inputs of data necessary for the processing from a system administrator or user. More specifically, input device 300 accepts inputs of a plurality of items of priority candidate data that are candidates for priority data. Input device 300 also accepts inputs of worker assignment conditions, which are conditions for determining the equipment that each worker is in charge of. Worker assignment conditions specifically include a maximum number of units of equipment that each worker is in charge of, the number of workers, a list of manufacturing equipment, and simulation conditions.

Display device 400 is one example of an output device that outputs the processing result of information processing device 200. The processing result includes the selected priority data and/or worker assignment data. Display device 400 is, for example, a liquid crystal display device or organic electroluminescent (EL) device. Display device 400 is a touch panel display, and may be integrated with input device 300.

Information processing system 10 may include, instead of or in addition to display device 400, an audio output device that outputs the processing result of information processing device 200.

### 3. Functional Configuration of Information Processing Device

Next, the functional configuration of information processing device 200 according to the present embodiment will be described with reference to FIG. 3. FIG. 3 is a block diagram illustrating the configuration of information processing device 200 according to the present embodiment.

As illustrated in FIG. 3, information processing device 200 includes data obtainer 211, data accumulator 212, distribution estimator 213, model storage 214, priority candidate obtainer 221, condition obtainer 222, worker assignment candidate generator 223, equipment operating rate estimator 224, optimization determiner 225, and outputter 226.

Data obtainer 211 obtains an operating status and a work status from each of the plurality of units of manufacturing equipment 100. Data obtainer 211 records each obtained operating status and work status in data accumulator 212.

Data accumulator 212 converts the operating statuses and work statuses into a database and accumulates them in a storage device as operating performance data and work performance data. The storage device is a non-volatile storage device such as a hard disk drive (HDD) or a solid state drive (SSD). The storage device is included in information processing device 200, but may be included in another device communicably connected via a network.

Using the accumulated operating performance data, distribution estimator 213 estimates, for each unit of equipment, an operating time distribution which is a joint distribution of operating time and stoppage factors. More specifically, distribution estimator 213 estimates the operating time distribution by performing machine learning using the operating performance data as input data.

Using the accumulated work performance data, distribution estimator 213 estimates a work time distribution for each stoppage factor. More specifically, distribution estimator 213 estimates the work time distribution by performing machine learning using the work performance data as input data.

The distribution estimation is performed by constructing a predetermined estimation model via machine learning. The estimation model is, for example, a regression model using Bayesian estimation, but is not limited thereto. The machine learning method is not particularly limited. For example, as supervised learning methods, methods using classifiers, methods using support vector machines, decision tree methods, and deep convolutional neural network methods can be used.

Model storage 214 stores the estimation model constructed by machine learning in a storage device. More specifically, model storage 214 stores the work time distribution for each stoppage factor and the operating time distribution for each unit of equipment. The storage device may be the same as or different from the storage device used by data accumulator 212 for accumulating data.

Priority candidate obtainer 221 obtains a plurality of items of priority candidate data input via input device 300.

Condition obtainer 222 obtains worker assignment conditions input via input device 300.

Worker assignment candidate generator 223 generates a plurality of items of worker assignment candidate data which are candidates for worker assignment data. In the present embodiment, worker assignment candidate generator 223 generates a plurality of items of worker assignment candidate data based on the obtained worker assignment conditions.

Equipment operating rate estimator 224 estimates an equipment operating rate of a plurality of units of equipment that the worker is in charge of (hereinafter also referred to as “overseen-equipment operating rate”). More specifically, equipment operating rate estimator 224 estimates the worker's overseen-equipment operating rate based on the plurality of items of priority candidate data and the trained estimation model (work time distribution and operating time distribution). Equipment operating rate estimator 224 estimates the overseen-equipment operating rate for each worker when there are a plurality of workers.

In the present embodiment, the overseen-equipment operating rate is a ratio of total operating time to a sum of total operating time and total downtime. The total operating time is a sum of the operating times of each of the plurality of units of overseen equipment. The total downtime is a sum of the downtimes of each of the plurality of units of overseen equipment. Stated differently, the overseen-equipment operating rate is expressed by the following Equation (1).

$$\begin{matrix}[ Math . 1 ] & \\ \begin{matrix}overseen - equipment \\ operating rate\end{matrix} = \frac{total operating time}{total operating time + total downtime} & ( 1 )\end{matrix}$$

The operating time and downtime of each unit of overseen equipment are estimated based on the trained estimation model. A specific method for estimating the overseen-equipment operating rate will be described later.

For each item of worker assignment candidate data, equipment operating rate estimator 224 estimates the overseen-equipment operating rate for each worker based further on the plurality of items of worker assignment candidate data. Furthermore, for each item of worker assignment candidate data, equipment operating rate estimator 224 estimates an overall operating rate, which is an equipment operating rate for the plurality of units of manufacturing equipment 100 as a whole, based on the overseen-equipment operating rate for each worker and the priority data used to calculate the overseen-equipment operating rate.

The overall operating rate is calculated by calculating, for each worker, a value that is a product of (i) the ratio of the units of equipment overseen by the worker to the total units of equipment and (ii) the operating rate of equipment overseen by that worker, and totaling the calculated values. In other words, the overall operating rate is expressed by the following Equation (2).

$$\begin{matrix}[ Math . 2 ] & \\ \begin{matrix}overall equipment \\ operating rate\end{matrix} = {\sum }_{i} ( \frac{\begin{matrix}units of equipment \\ overseen by worker i\end{matrix}}{total units of equipment} \times \begin{matrix}operating rate of equipment \\ overseen by worker i\end{matrix} ) & ( 2 )\end{matrix}$$

Optimization determiner 225 selects, from among the plurality of items of priority candidate data, priority data for which the overseen-equipment operating rate is greater than or equal to the threshold value. More specifically, optimization determiner 225 selects priority data with the highest overseen-equipment operating rate as optimal priority data. The selection of priority data is performed per worker. The selection of priority data per worker is performed for each item of worker assignment candidate data.

Optimization determiner 225 also selects, from among the plurality of items of worker assignment candidate data, worker assignment data for which the overall operating rate is greater than or equal to the threshold value, and priority data selected corresponding to that worker assignment data. More specifically, optimization determiner 225 selects the worker assignment data with the highest overall operating rate as the optimal worker assignment data, and also selects the optimal priority data corresponding to that optimal worker assignment data. Optimization determiner 225 instructs worker assignment candidate generator 223 to generate worker assignment data until a sufficient number (for example, a specified number) of candidates necessary for selecting the optimal worker assignment data and optimal priority data is reached.

Outputter 226 outputs the worker assignment data and priority data selected by optimization determiner 225. In the present embodiment, outputter 226 outputs the worker assignment data and priority data to display device 400.

### 4. Information Processed by Information Processing System

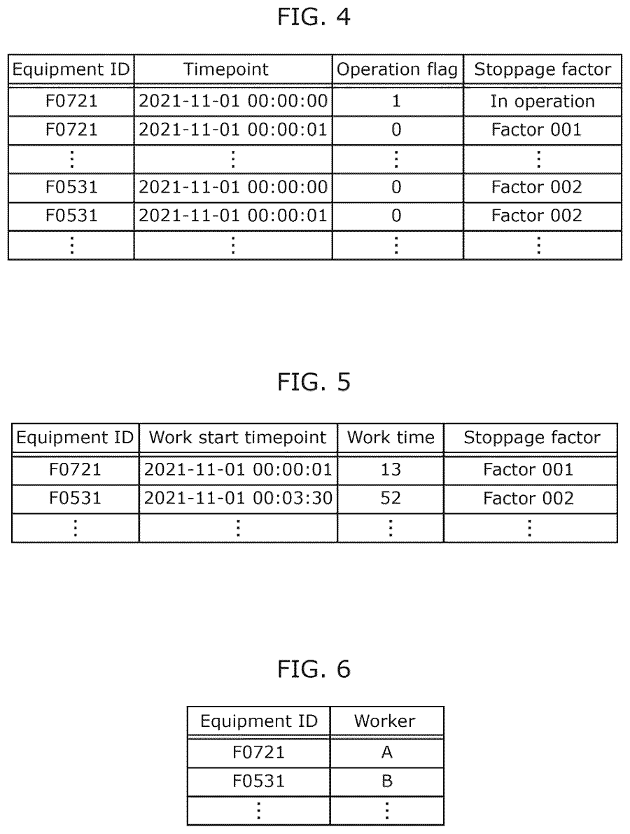

Next, information processed by information processing system 10 according to the present embodiment will be described with reference to FIG. 4 through FIG. 8.

### 4-1. Operating Performance Data

FIG. 4 illustrates one example of operating performance data. The operating performance data illustrated in FIG. 4 is data indicating what kind of operating status each unit of equipment was in at each timepoint. The operating performance data is converted into a database by data accumulator 212 based on information obtained by data obtainer 211, and then recorded in a storage device.

As illustrated in FIG. 4, the operating performance data includes equipment IDs, timepoints, operation flags, and stoppage factors. Equipment ID is unique identification information assigned to each unit of manufacturing equipment 100. The timepoint is the point in time at which data obtainer 211 obtained the data, or the point in time at which manufacturing equipment 100 transmitted the data. The operation flag is a flag indicating whether manufacturing equipment 100 is operating or stopped. Here, “1” indicates that manufacturing equipment 100 is operating, and “0” indicates that manufacturing equipment 100 is stopped. The stoppage factor is identification information (a stoppage code) of the cause of the stoppage of stopped manufacturing equipment 100 (that is, equipment whose operation flag is “0”).

### 4-2. Work Performance Data

FIG. 5 illustrates one example of work performance data. The work performance data illustrated in FIG. 5 is data indicating the work time required for recovery work for stoppages that occur in each unit of equipment. The work performance data is converted into a database by data accumulator 212 based on information obtained by data obtainer 211, and then recorded in a storage device.

As illustrated in FIG. 5, the work performance data includes equipment IDs, work start timepoints, work times, and stoppage factors. Equipment ID is unique identification information assigned to each unit of manufacturing equipment 100, and here indicates manufacturing equipment 100 that has stopped. The work start timepoint is the point in time at which the worker started the recovery work. The work time is the time required by the worker for the recovery work. Instead of the work time, a work end timepoint or the operation timepoint of manufacturing equipment 100 may be included. The stoppage factor is the factor that caused manufacturing equipment 100 to stop.

### 4-3. Worker Assignment Data

FIG. 6 illustrates one example of worker assignment data. The worker assignment data illustrated in FIG. 6 is data indicating the worker in charge of recovery work for each unit of equipment. The worker assignment data is one selected by optimization determiner 225 from among a plurality of items of worker assignment candidate data generated by worker assignment candidate generator 223. The worker assignment data is output to display device 400 via outputter 226.

### 4-4. Priority Data

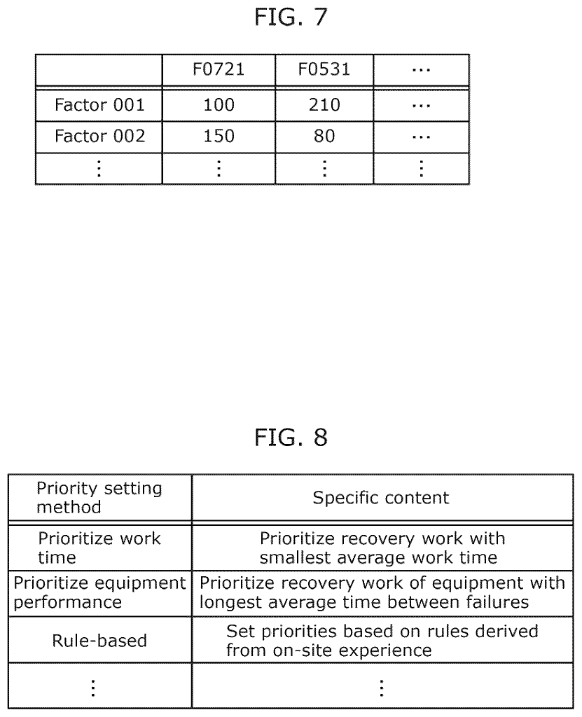

FIG. 7 illustrates one example of priority data. The priority data illustrated in FIG. 7 is data indicating the priority of recovery work for each combination of equipment and stoppage factor. The priority data is one selected by optimization determiner 225 from among a plurality of items of priority candidate data obtained by priority candidate obtainer 221 via input device 300.

### 5. Priority Candidate Data

In the present embodiment, information processing device 200 utilizes a plurality of items of priority candidate data. The plurality of items of priority candidate data are mutually different priority data. Each of the plurality of items of priority candidate data is created based on a predetermined priority setting method.

FIG. 8 illustrates one example of a priority setting method. As illustrated in FIG. 8, priority setting methods include, for example, a method that prioritizes work time, a method that prioritizes equipment performance, and a method based on predetermined rules (rule-based).

In the method that prioritizes work time, the recovery work with the smallest average work time is prioritized. More specifically, an average work time is calculated for each combination of equipment and stoppage factor, and the shorter the calculated average work time is, the higher the priority of the corresponding combination is set, and the longer the calculated average work time is, the lower the priority of the corresponding combination is set. The priority of the combination with the shortest average work time is set the highest.

In the method that prioritizes equipment performance, the recovery work of the equipment with the longest average time between failures is prioritized. More specifically, an average time between failures is calculated for each combination of equipment and stoppage factor, and the longer the calculated average time between failures is, the higher the priority of the corresponding combination is set, and the shorter the calculated average time between failures is, the lower the priority of the corresponding combination is set. The priority of the combination with the longest average time between failures is set the highest.

In the rule-based method, priorities are set based on rules derived from on-site experience. By the worker actually performing recovery work in factory 1, the worker can gain experience as to which recovery work tends to lead to improved productivity of the production system. In the rule-based method, priorities are set based on such on-site experience.

The priority setting methods are not limited to the above examples. For example, the priority may be set by combining the work time and equipment performance with weighting. Alternatively, the priority may be set by correcting, based on rules, a priority that has been set based on a method of prioritizing the work time or equipment performance.

Utilizing a plurality of items of priority candidate data makes it possible to select priority data suitable for improving productivity. Hereinafter, examples of undesirable priority data and desirable priority data will be described.

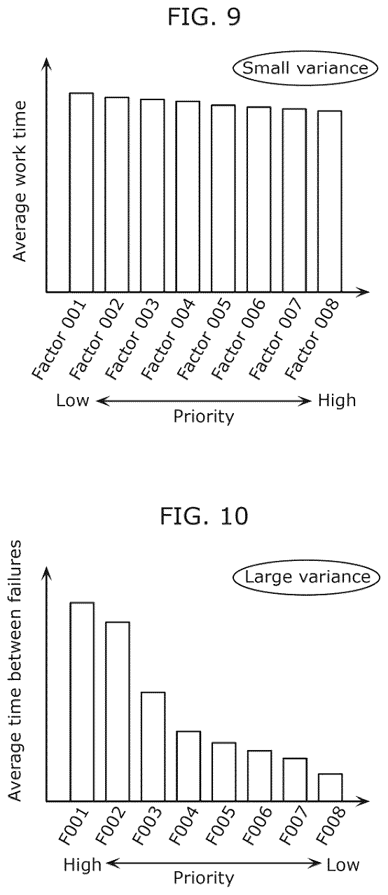

FIG. 9 illustrates the relationship between priority and one example of average work time per stoppage factor. In FIG. 9, the horizontal axis represents stoppage factors, and the vertical axis represents average work time. The stoppage factors are arranged in descending order of average work time.

In this case, based on the method that prioritizes work time, the priority for “Factor 008” with the shortest average work time is set high, and the priority for “Factor 001” with the longest average work time is set low. However, in the example illustrated in FIG. 9, the variance in average work time is small, and the benefit of setting priorities is low. Stated differently, regardless of which factor recovery work is performed for, the average work time hardly changes, so there is little benefit in shortening the period of time that the equipment is stopped and lengthening the operating time. In other words, doing so does not necessarily lead to improved productivity. Therefore, for each stoppage factor illustrated in FIG. 9, priority data set based on a method that prioritizes work time is not very desirable priority data.

In contrast, FIG. 10 illustrates the relationship between priority and one example of average time between failures per unit of equipment. In FIG. 10, the horizontal axis represents equipment ID, and the vertical axis represents average time between failures. The equipment IDs are arranged in descending order of average time between failures.

In this case, based on the method that prioritizes equipment performance, the priority for “Equipment F001” with the longest average time between failures is set high, and the priority for “Equipment F008” with the shortest average time between failures is set low. In the example illustrated in FIG. 10, the variance in average time between failures is large, and thus the benefit of setting priorities is high. Stated differently, by prioritizing the recovery of equipment with longer average times between failures, it is expected that the operating time of the production system as a whole can be increased. Therefore, for each unit of equipment illustrated in FIG. 10, priority data set based on a method that prioritizes equipment performance is desirable priority data for improving productivity.

As described above, by selecting appropriate priority data according to the combination of equipment and stoppage factor, it is expected that productivity can be improved.

### 6. Operations

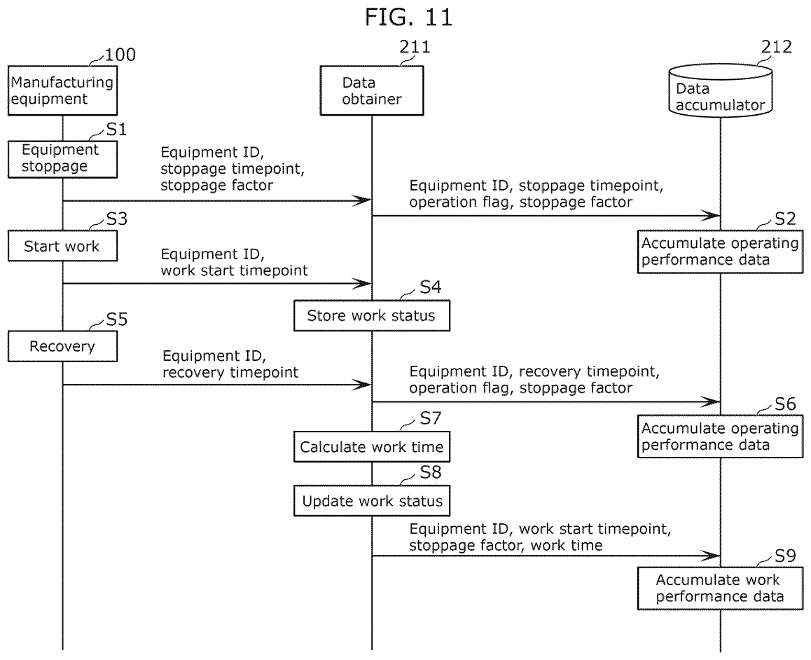

Next, operations performed by information processing system 10 according to the present embodiment will be described. The operations performed by information processing system 10 according to the present embodiment include two main processes: a learning phase and a usage phase. First, an overview of the processing in each of the learning phase and usage phase will be described using the sequence diagrams of FIG. 11 through FIG. 13.

### 6-1. Learning Phase

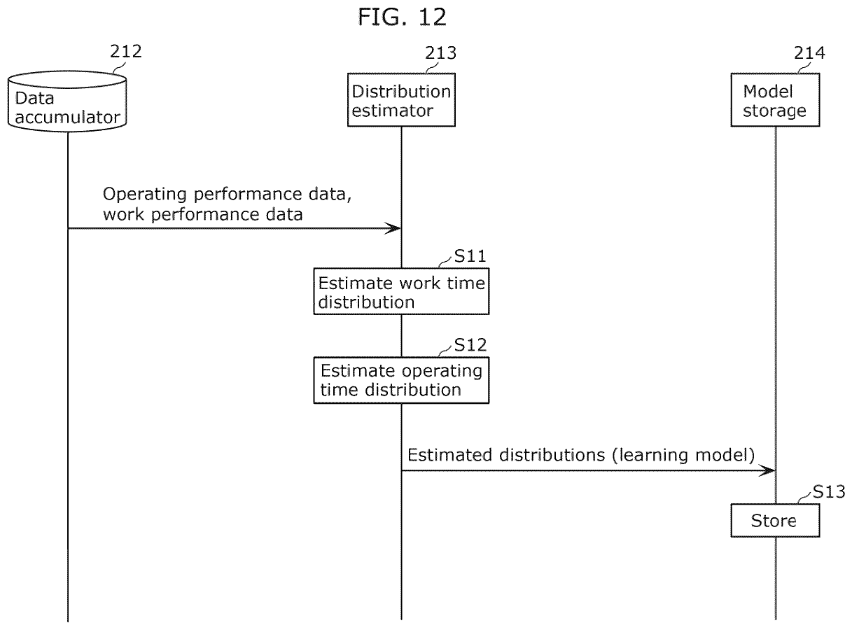

First, an overview of the processing in the learning phase will be described with reference to FIG. 11 and FIG. 12.

FIG. 11 is a sequence diagram illustrating a process for accumulating data (learning phase) by information processing system 10 according to the present embodiment. FIG. 12 is a sequence diagram illustrating a process for estimating a distribution (learning phase) by information processing system 10 according to the present embodiment. Although only a single unit of manufacturing equipment 100 is illustrated in FIG. 11, the same operations are performed for each of the plurality of units of manufacturing equipment 100.

In the present embodiment, as illustrated in FIG. 4, for each unit of manufacturing equipment 100, one record (row of recorded data) is generated every second and accumulated as operating performance data. Stated differently, the operating status is transmitted from manufacturing equipment 100 at regular intervals (for example, every second), and data accumulator 212 accumulates the operating performance data as time-series data representing the status of each unit of equipment in chronological order.

In this case, as illustrated in FIG. 11, when a stoppage occurs in manufacturing equipment 100 (S1), manufacturing equipment 100 transmits the equipment ID, stoppage timepoint, and stoppage factor to data obtainer 211 (information processing device 200). Data obtainer 211 transmits the equipment ID, stoppage timepoint, and stoppage factor transmitted from manufacturing equipment 100 to data accumulator 212.

Data accumulator 212 accumulates the equipment ID, stoppage timepoint, and stoppage factor as operating performance data (S2). More specifically, the operation flag corresponding to the stoppage timepoint is set to “0”, and the stoppage factor is recorded.

When recovery work is started for manufacturing equipment 100 that has stopped (S3), manufacturing equipment 100 transmits the equipment ID and the work start timepoint to data obtainer 211. The equipment ID and work start timepoint may be transmitted from a terminal device carried by the worker. Data obtainer 211 stores the received equipment ID and work start timepoint (S4).

When recovery work is completed and manufacturing equipment 100 recovers (starts operation) (S5), manufacturing equipment 100 transmits the equipment ID and the recovery timepoint (operation timepoint) to data obtainer 211. Data obtainer 211 transmits the equipment ID, recovery timepoint, and stoppage factor transmitted from manufacturing equipment 100 to data accumulator 212.

Data accumulator 212 accumulates the equipment ID, stoppage timepoint, and stoppage factor as operating performance data (S6). More specifically, the operation flag corresponding to the stoppage timepoint is set to “1”.

Data obtainer 211 calculates the work time (S7). More specifically, data obtainer 211 calculates the work time by subtracting the work start timepoint from the recovery timepoint. Data obtainer 211 updates the work status (S8). More specifically, data obtainer 211 transmits the calculated work time, equipment ID, work start timepoint, and stoppage factor to data accumulator 212. Data accumulator 212 accumulates the equipment ID, work start timepoint, work time, and stoppage factor as work performance data (S9).

The above processing is performed for each unit of manufacturing equipment 100 for a predetermined period. As a result, the storage device of data accumulator 212 accumulates the operating performance data and work performance data for a predetermined period. The predetermined period is, for example, a relatively long period such as one day, one week, or one month, but is not particularly limited. The larger the amount of data, the higher the accuracy of the distribution estimation by the machine learning, which will be described later.

Next, as illustrated in FIG. 12, distribution estimator 213 reads the operating performance data and work performance data for a predetermined period from the storage device of data accumulator 212, and performs estimation of the work time distribution using the read data (S11). Distribution estimator 213 performs estimation of the operating time distribution using the read data (S12). The specific processes for estimating the distributions will be described later. Next, the estimated distributions are stored in the storage device by model storage 214 (S13).

As described above, with information processing system 10 according to the present embodiment, in the learning phase, operating performance data and work performance data are collected, and the operating time distribution and work time distribution are estimated by machine learning using the collected data.

### 6-2. Usage Phase

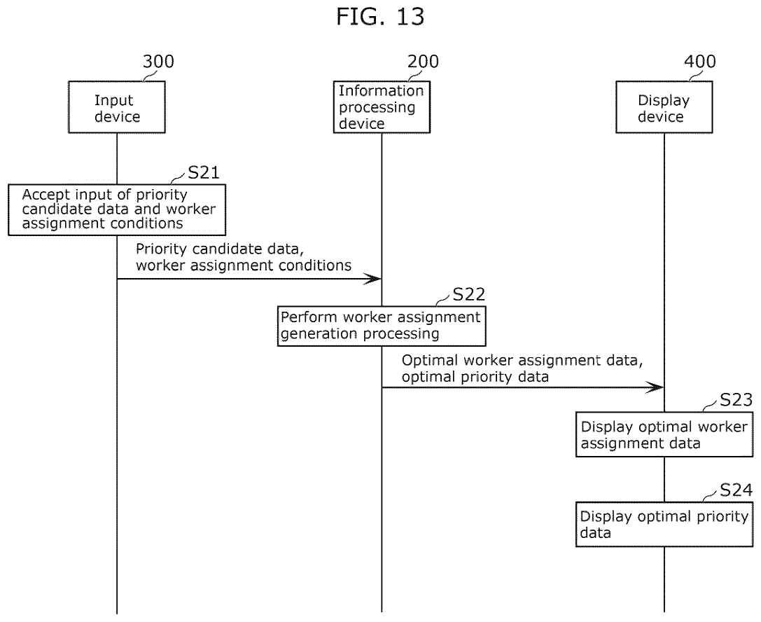

Next, an overview of the processing in the usage phase will be described with reference to FIG. 13. FIG. 13 is a sequence diagram illustrating a process for determining optimal priority data and optimal worker assignment data (usage phase) by information processing system 10 according to the present embodiment.

As illustrated in FIG. 13, first, input device 300 accepts input of priority candidate data and worker assignment conditions (S21). The input priority candidate data and worker assignment conditions are transmitted to priority candidate obtainer 221 and condition obtainer 222, respectively, of information processing device 200.

Next, information processing device 200 performs worker assignment generation processing (S22). In the worker assignment generation processing, the optimal priority data and the optimal worker assignment data are determined. The processes will be described in greater detail later. The determined optimal priority data and optimal worker assignment data are transmitted to display device 400.

Next, display device 400 displays the optimal worker assignment data (S23) and displays the optimal priority data (S24). Note that the optimal priority data may be displayed before displaying the optimal worker assignment data, and the optimal worker assignment data and the optimal priority data may be displayed simultaneously.

As described above, with information processing system 10 according to the present embodiment, in the usage phase, optimal worker assignment data and optimal priority data are determined and displayed using a trained model (estimated distribution) obtained by machine learning. The administrator or the like of factory 1 can contribute to improving the productivity of the production system by creating the worker assignments and the order of each recovery work based on the displayed optimal worker assignment data and optimal priority data.

### 7. Specific Processing

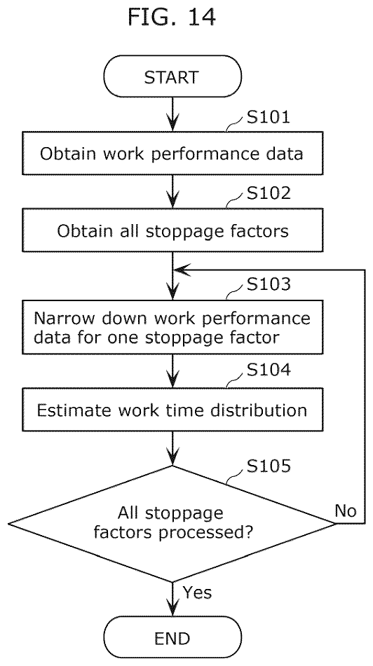

Next, specific processing performed by information processing system 10 according to the present embodiment will be described in greater detail with reference to FIG. 14 through FIG. 18.

### 7-1. Work Time Distribution Estimation

First, the specific processing of the work time distribution estimation (step S11 in FIG. 12) will be described with reference to FIG. 14. FIG. 14 is a flowchart illustrating a process for estimating a work time distribution by information processing system 10 according to the present embodiment.

As illustrated in FIG. 14, first, distribution estimator 213 of information processing device 200 reads and obtains the work performance data for a predetermined period from the storage device of data accumulator 212 (S101). Next, distribution estimator 213 obtains all stoppage factors included in the work performance data (S102).

Next, distribution estimator 213 selects one stoppage factor and narrows down the work performance data corresponding to that stoppage factor (S103). Using the narrowed-down work performance data, distribution estimator 213 estimates the work time distribution of the selected stoppage factor by performing machine learning (S104).

Distribution estimator 213 repeats steps S103 and S104 until the work time distribution is estimated for all stoppage factors (S105). In the repetition, in step S103, a stoppage factor for which the work time distribution has not been estimated is selected.

When the work time distribution is estimated for all stoppage factors (Yes in S105), the process ends.

### 7-2. Operating Time Distribution Estimation

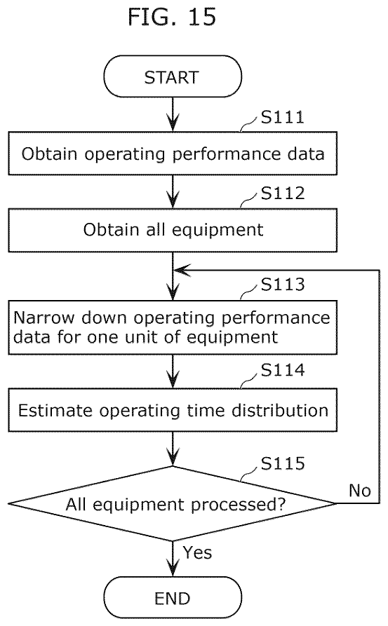

Next, the specific processing of the operating time distribution estimation (step S12 in FIG. 12) will be described with reference to FIG. 15. FIG. 15 is a flowchart illustrating a process for estimating an operating time distribution by information processing system 10 according to the present embodiment.

As illustrated in FIG. 15, first, distribution estimator 213 of information processing device 200 reads and obtains the operating performance data for a predetermined period from the storage device of data accumulator 212 (S111). Next, distribution estimator 213 obtains all equipment (specifically, equipment IDs) included in the operating performance data (S112).

Next, distribution estimator 213 selects one unit of equipment and narrows down the operating performance data corresponding to that unit (S113). Using the narrowed-down operating performance data, distribution estimator 213 estimates the operating time distribution (joint distribution of operating time and stoppage factors) of the selected equipment by performing machine learning (S114).

Distribution estimator 213 repeats steps S113 and S114 until the operating time distribution is estimated for all equipment (No in S115). In the repetition, in step S113, a unit of equipment for which the operating time distribution has not been estimated is selected.

When the operating time distribution is estimated for all equipment (Yes in S115), the process ends.

### 7-3. Worker Assignment Generation Processing

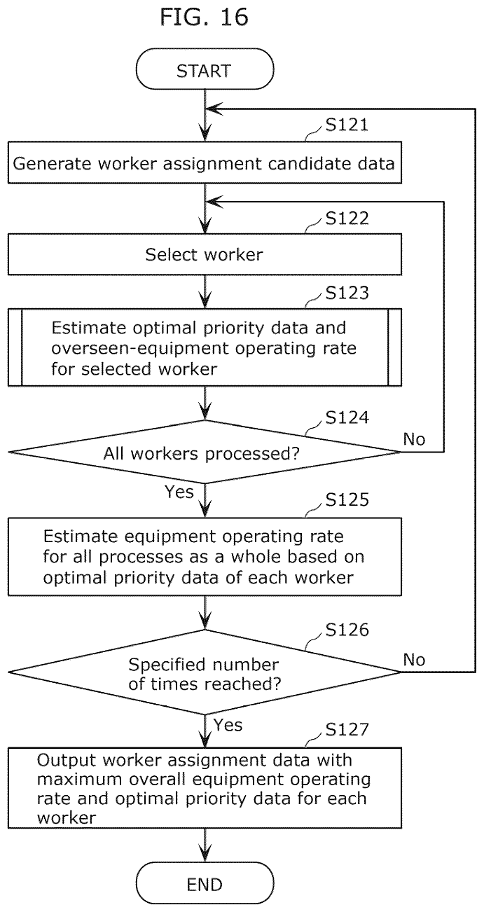

Next, the specific processing of the worker assignment generation (step S22 in FIG. 13) will be described with reference to FIG. 16. FIG. 16 is a flowchart illustrating worker assignment generation processing performed by information processing system 10 according to the present embodiment.

First, as illustrated in FIG. 16, worker assignment candidate generator 223 generates worker assignment candidate data (S121). More specifically, worker assignment candidate generator 223 obtains worker assignment candidate data that satisfies the worker assignment conditions obtained by condition obtainer 222.

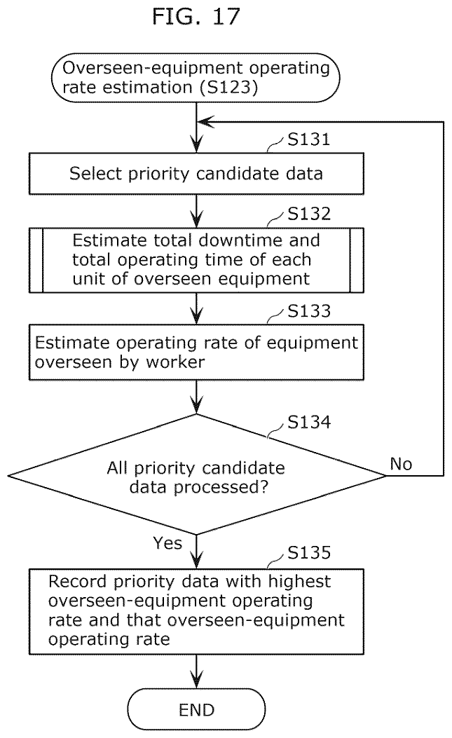

Next, equipment operating rate estimator 224 selects one worker (specifically, a worker ID) (S122), and estimates the optimal priority data and the overseen-equipment operating rate for the selected worker (S123). A specific method for estimating the overseen-equipment operating rate will be described later with reference to FIG. 17.

Steps S122 and S123 are repeated until the optimal priority data and the overseen-equipment operating rate are estimated for all workers (No in S124). In the repetition, in step S122, a worker for which the optimal priority data has not been estimated is selected.

When the optimal priority data and the overseen-equipment operating rate are estimated for all workers (Yes in S124), equipment operating rate estimator 224 estimates the equipment operating rate for all processes as a whole (overall operating rate) based on the optimal priority data of each worker (S125). The estimation of the overall operating rate is performed based on the above-mentioned Equation (2). The estimated overall operating rate is stored in a storage device together with the optimal priority data for each worker.

Next, if the number of times the processing of the above-described steps S121 to S125 has been executed has not reached the specified number of times (No in S126), the processing of steps S121 to S125 is repeated. Note that in the repetition, worker assignment candidate generator 223 generates worker assignment candidate data that is different from the already generated worker assignment candidate data. By repeating each step, the optimal priority data for each worker and the overall operating rate are estimated for each of the plurality of items of worker assignment candidate data.

When the specified number of times is reached (Yes in S126), optimization determiner 225 determines the worker assignment data with the maximum overall operating rate as the optimal worker assignment data, and outputter 226 outputs the optimal worker assignment data and the optimal priority data for each worker corresponding to that optimal worker assignment data (S127).

The specified number of times is a number specified in advance by a system administrator or the like. The greater the specified number of times is, the more the number of items of worker assignment candidate data increases, so the possibility of more optimal worker assignment data being created becomes higher. If the specified number of times is reduced, the processing time becomes shorter, so it becomes possible to determine the optimal worker assignment data in a short period of time.

### 7-4. Overseen-equipment Operating Rate Estimation

Next, the processing for estimating the overseen-equipment operating rate for each worker (S123) will be described with reference to FIG. 17. FIG. 17 is a flowchart illustrating processing for estimating an overseen-equipment operating rate performed by information processing system 10 according to the present embodiment.

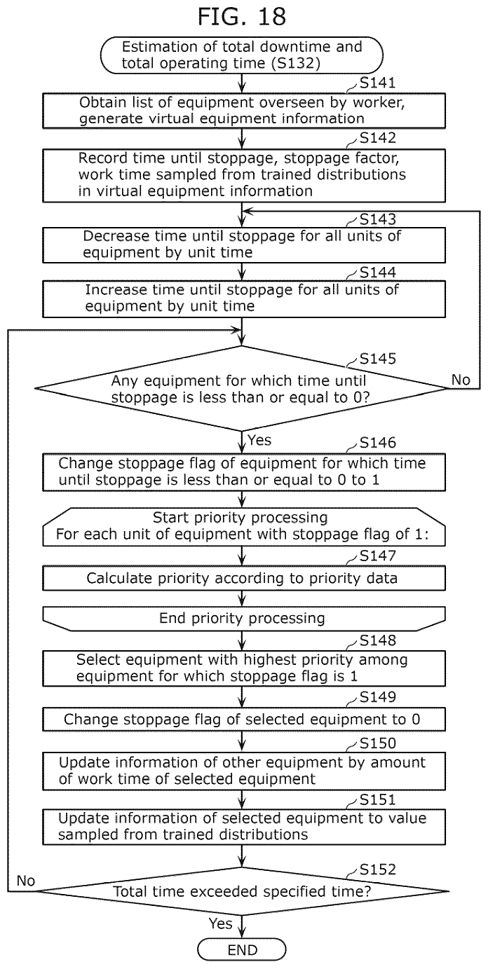

First, as illustrated in FIG. 17, equipment operating rate estimator 224 selects one item of priority candidate data (S131). Next, equipment operating rate estimator 224 estimates the total downtime and total operating time of each of the plurality of units of overseen equipment the worker is in charge of based on the selected priority candidate data (S132). A specific example of the processing for estimating the total downtime and total operating time will be described later with reference to FIG. 18.

Next, equipment operating rate estimator 224 estimates the operating rate of the equipment overseen by the worker based on the estimated total downtime and total operating time (S133). The estimation of the overseen-equipment operating rate is performed based on the above-mentioned Equation (1). The estimated overseen-equipment operating rate is stored in a storage device in association with the worker.

Steps S131 to S133 are repeated until the overseen-equipment operating rate is estimated for all priority candidate data (No in S134). Note that in the repetition, in step S131, priority candidate data for which the overseen-equipment operating rate has not been selected is selected.

Once the overseen-equipment operating rate is estimated for all priority candidate data (Yes in S134), equipment operating rate estimator 224 records the priority data with the highest overseen-equipment operating rate and that overseen-equipment operating rate in the storage device (S135).

### 7-5. Estimation of Total Downtime and Total Operating Time

Next, the processing for estimating the total downtime and total operating time (S132) will be described with reference to FIG. 18. FIG. 18 is a flowchart illustrating processing for estimating total downtime and total operating time by information processing system 10 according to the present embodiment.

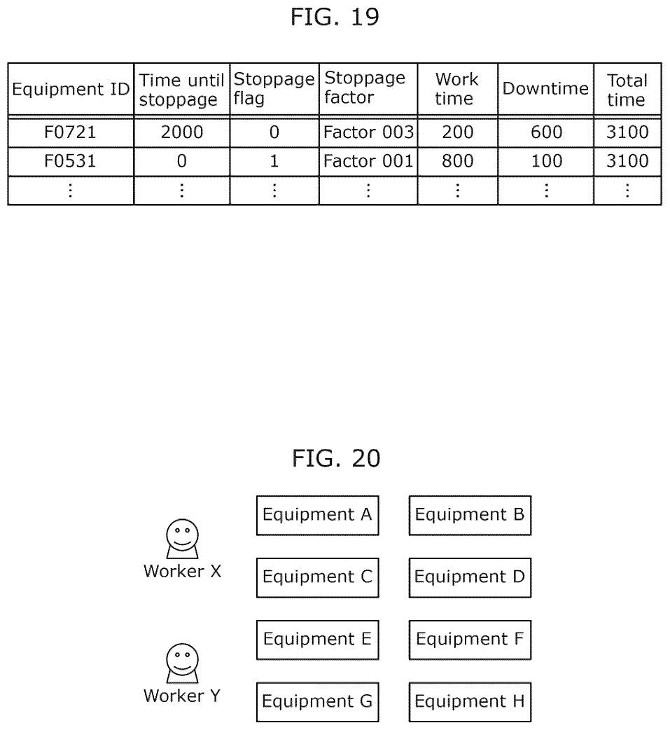

As illustrated in FIG. 18, first, equipment operating rate estimator 224 obtains a list of equipment overseen by a worker based on the worker assignment candidate data, and generates virtual equipment information (S141). Virtual equipment information is information used for simulation to estimate the total downtime and total operating time, and is, for example, the information illustrated in FIG. 19. FIG. 19 illustrates one example of virtual equipment information. In the example illustrated in FIG. 19, for each equipment ID, time until stoppage, stoppage flag, stoppage factor, work time, downtime, and total time are associated with each other. The stoppage flag indicates “0” for operating and “1” for stopped. Note that the operating time of the equipment is calculated by subtracting the downtime from the total time.

Next, equipment operating rate estimator 224 records the values of each item in the virtual equipment information based on the trained model (work time distribution and operating time distribution) stored in model storage 214 (S142). More specifically, equipment operating rate estimator 224 records, for each unit of equipment in the virtual equipment information, the time until stoppage, stoppage factor, and work time sampled from each of the work time distribution and the operating time distribution. Downtime and total time are each record as 0 as an initial value.

Next, equipment operating rate estimator 224 decreases the time until stoppage for all units of equipment by a unit time (for example, one second) (S143), and then increases the total time for all units of equipment by the unit time (for example, one second) (S144). Note that the unit time does not need to be one second, and may be any arbitrarily set value.

If there is no equipment for which the time until stoppage is less than or equal to 0 (No in S145), the process returns to step S143 and increases the time to be decreased by the unit time (for example, one second). The process of decreasing the time until stoppage for all units of equipment by the unit time and increasing the total time for all units of equipment by the unit time is repeatedly performed until there is equipment for which the time until stoppage is less than or equal to 0.

If there is equipment for which the time until stoppage is less than or equal to 0 (Yes in S145), the stoppage flag for that equipment is changed to “1” (S146).

Next, for each unit of equipment for which the stoppage flag is “1”, equipment operating rate estimator 224 calculates a priority according to the priority data (S147). Next, equipment operating rate estimator 224 selects the equipment with the highest priority among the equipment for which the stoppage flag is “1” (S148), and changes the stoppage flag for the selected equipment to “0” (S149).

Next, equipment operating rate estimator 224 updates the information of the other equipment by the amount of the work time of the selected equipment (S150). More specifically, equipment operating rate estimator 224 decreases the time until stoppage for operating equipment by the amount of the work time of the selected equipment, and increases the downtime of stopped equipment and the total time of all equipment. For equipment for which the time until stoppage falls below 0, equipment operating rate estimator 224 adds the amount by which it fell below to the downtime.

Next, equipment operating rate estimator 224 updates the time until stoppage, stoppage factor, and work time of the selected equipment to different values sampled from each of the work time distribution and operating time distribution (S151). Steps S145 to S151 described above are repeated as long as the total time does not exceed a predetermined specified time (No in S152). When the total time exceeds the specified time (Yes in S152), the process ends.

The total downtime is a sum of the downtimes of each unit of equipment in the virtual equipment information at a point when the total time exceeds the specified time. The total operating time is a sum of values obtained by subtracting the downtime from the total time for each unit of equipment.

As described above, the total downtime and total operating time can be estimated by simulating the stoppage and operation of the equipment. With this, the equipment operating rate (overseen-equipment operating rate) is calculated based on the above-mentioned Equation (1) (S133 in FIG. 17).

### Implementation Example

Hereinafter, processing performed by information processing system 10 according to the present embodiment will be described with reference to a simple implementation example.

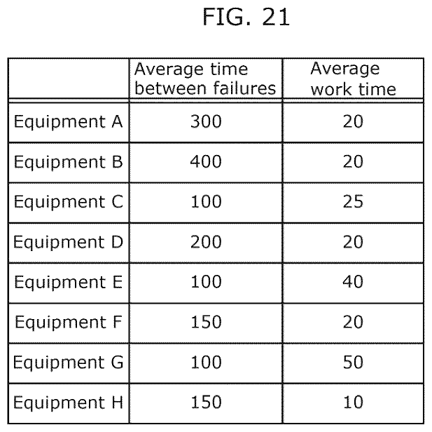

FIG. 20 illustrates eight units of equipment A to H for which two workers X and Y are in charge of recovery work. FIG. 21 illustrates the average time between failures and average work time for the eight units of equipment A to H illustrated in FIG. 20. Hereinafter, an example in which the average work time is the same for workers X and Y will be described, but the average work time may be different between the workers.

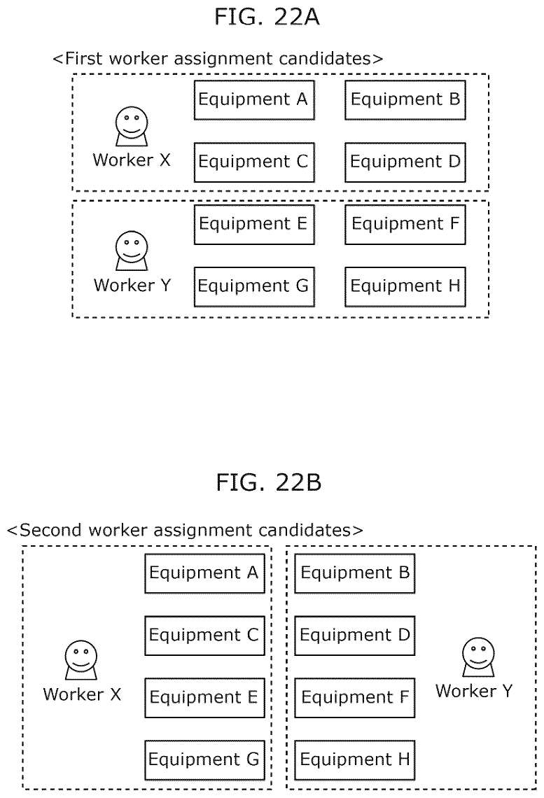

FIG. 22A illustrates the first worker assignment candidates in the example illustrated in FIG. 20. FIG. 22B illustrates the second worker assignment candidates in the example illustrated in FIG. 20. In the first worker assignment candidates, the equipment assigned to worker X are the four units of equipment A to D, and the equipment assigned to worker Y are the four units of equipment E to H. In the second worker assignment candidates, the equipment assigned to worker X are the four units of equipment A, C, E, and G, and the equipment assigned to worker Y are the four units of equipment B, D, F, and H.

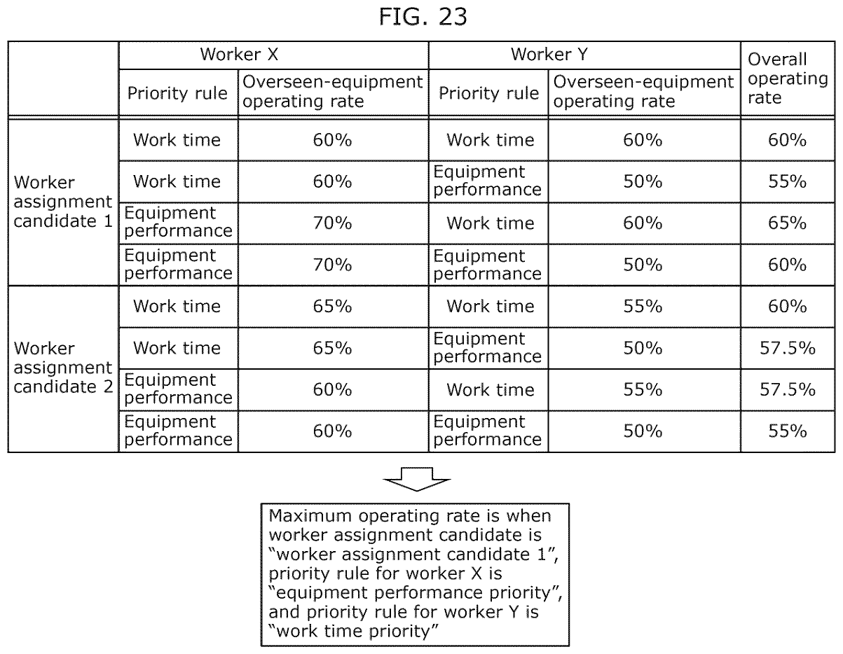

FIG. 23 illustrates the estimated equipment operating rate results for the example illustrated in FIG. 20. FIG. 23 illustrates the estimated equipment operating rate for each combination of worker assignment candidate, priority rules, and workers. Here, two priority rules are adopted: a rule that prioritizes work time (work time priority) and a rule that prioritizes equipment performance (equipment performance priority). The equipment operating rates are obtained as a result of performing the processing illustrated in FIG. 17 and FIG. 18.

The overall operating rates are calculated based on the above-mentioned Equation (2). Here, since the number of units of equipment that each of worker X and Y is in charge of is the same, the overall operating rate is the average of the overseen-equipment operating rate of worker X and the overseen-equipment operating rate of worker Y.

As illustrated in FIG. 23, the highest overall operating rate value is 65%. The highest overall operating rate is in the case where the worker assignment candidate is “worker assignment candidate 1”, the priority rule for worker X is “equipment performance priority”, and the priority rule for worker Y is “work time priority”. Accordingly, outputter 226 outputs this information along with the overseen-equipment operating rate for each worker and the overall operating rate.

As illustrated by way of example in FIG. 23, cases arise where the overseen-equipment operating rate for each worker and the overall operating rate differ depending on the combination of priority rules and worker assignment candidates. Calculating the overall operating rate for each combination makes it possible to select and output an appropriate priority rule (priority data) and worker assignment candidate (worker assignment data).

Although the combination corresponding to the highest overall operating rate is selected in this example, what is selected is not limited to this example. For example, there may be cases where it is sufficient to secure an overall operating rate greater than or equal to a predetermined value depending on factors such as the takt time difference with the subsequent process of the plurality of subject units of equipment. In such cases, information processing device 200 may select and output a combination for which the overall operating rate is greater than or equal to a threshold value.

### Other Embodiments

Hereinbefore, the information processing method and the information processing device according to one or more aspects have been described based on embodiments, but the present disclosure is not limited to these embodiments. Various modifications to the present embodiment that may be conceived by those skilled in the art, as well as embodiments resulting from combinations of elements from different embodiments, are intended to be included within the scope of the present disclosure as long as these do not depart from the essence of the present disclosure.

For example, the above embodiment presented an example in which a plurality of workers 2A to 2E are engaged in work in factory 1, but the present disclosure is not limited to this example. The number of workers engaged in work in factory 1 may be only one. In such cases, since the worker is in charge of recovery work for all manufacturing equipment 100 in factory 1, the information processing system does not need to create worker assignment data. Moreover, the information processing system only needs to determine the priority data for a single worker. In such cases, for example, only step S123 in the flowchart of FIG. 16 is executed, and the result is output.

For example, the equipment operating rate of the plurality of units of overseen equipment that the worker is in charge of was calculated using the total downtime and total operating time of the plurality of units of overseen equipment, but the present disclosure is not limited to this. For example, the equipment operating rate of the plurality of units of overseen equipment may be an average value of the equipment operating rates calculated for each unit of overseen equipment.

The communication method between devices described in the above embodiment is not particularly limited. In cases in which wireless communication is performed between devices, the wireless communication method (communication standard) is, for example, short-range wireless communication such as ZigBee (registered trademark), Bluetooth (registered trademark), or wireless local area network (LAN). Alternatively, the wireless communication method (communication standard) may be communication via a wide area communication network such as the Internet. Wired communication may be performed between devices instead of wireless communication. More specifically, wired communication is communication using power line communication (PLC) or wired LAN.

In the above embodiments, processing performed by a particular processing unit may be performed by a different processing unit. The order of the plurality of processes may be changed, or the plurality of processes may be executed in parallel. In the above embodiments, the allocation of elements of the work notification system to the devices is merely one example. For example, an element included in one device may be included in another device.

For example, the processing described in the above embodiments may be realized by centralized processing using a single device (system), or may be realized by distributed processing using a plurality of devices. The processor that executes the program described above may be a single processor or a plurality of processors. Stated differently, the processing may be centralized or distributed.

In the above embodiments, all or part of the elements such as the controller may be configured using dedicated hardware, or may be implemented by executing a software program suitable for each element. Each element may be implemented by a program execution unit such as a Central Processing Unit (CPU) or processor reading and executing a software program recorded on a recording medium such as an HDD or semiconductor memory.

The elements such as the controller may be configured of one or more electronic circuits. The one or more electronic circuits may each be a general-purpose circuit or a dedicated circuit.

The one or more electronic circuits may include, for example, a semiconductor device, an integrated circuit (IC), or a large scale integrated (LSI) circuit. The IC or LSI circuit may be integrated on a single chip, or may be integrated on a plurality of chips. Although these circuits are referred to as IC or LSI circuit here, the terminology may change depending on the degree of integration, and these circuits may be called system LSI circuit, a very large scale integrated (VLSI) circuit, or an ultra large scale integrated (ULSI) circuit. A field programmable gate array (FPGA) that is programmed after manufacturing the LSI circuitry can be used for the same purpose.

General or specific aspects of the present disclosure may be realized as a system, an apparatus or device, a method, an integrated circuit, or a computer program. Alternatively, the computer program may be realized on a computer-readable non-transitory recording medium such as an optical disc, an HDD, or semiconductor memory. Any given combination of a system, an apparatus or device, a method, an integrated circuit, a computer program, and a recording medium may be used to realize the aspects.

Various changes, substitutions, additions, omissions, etc., can be made to each of the above embodiments within the scope of the claims or their equivalents.

### INDUSTRIAL APPLICABILITY

The present disclosure is applicable as an information processing method or the like that can support the improvement of productivity, and is applicable, for example, in factory management systems and factory production systems.

1. An information processing method comprising:
obtaining items of priority data each representing a priority for a combination of a unit of equipment among units of equipment and a stoppage factor, the priority being for recovery work for equipment that has stopped among the units of equipment;
estimating, for each item of the priority data, an equipment operating rate of overseen equipment among the units of equipment, the overseen equipment being equipment that a worker who performs the recovery work is in charge of;
selecting, from among the items of priority data, priority data for which the equipment operating rate is greater than or equal to a threshold value; and
outputting the priority data selected.

2. The information processing method according to claim 1, wherein
in the estimating, the equipment operating rate is estimated as a ratio of (i) a sum of operating times of each unit of the overseen equipment to (ii) a sum of the operating times of each unit of the overseen equipment and downtimes of each unit of the overseen equipment.

3. The information processing method according to claim 1, wherein
in the selecting, the item of priority data for which the equipment operating rate is highest is selected.

4. The information processing method according to claim 1, further comprising:
generating worker assignment data representing assignments of workers to the overseen equipment the workers are in charge of among the units of equipment, wherein the estimating and the selecting are performed for each item of the worker assignment data and for each of the workers; and
estimating an overall operating rate for each item of the worker assignment data based on the priority data and the equipment operating rate of the overseen equipment for each of the workers, the overall operating rate being an equipment operating rate for the units of equipment as a whole, wherein
in the outputting, the worker assignment data for which the overall operating rate is greater than or equal to a threshold value and the priority data for each of the workers are output.

5. The information processing method according to claim 4, further comprising:
obtaining worker assignment conditions including a total number of the units of equipment and a total number of the workers, wherein
in the generating, the worker assignment data is generated based on the worker assignment conditions.

6. The information processing method according to claim 4, wherein
in the outputting, the worker assignment data for which the overall operating rate is highest and the priority data for each of the workers are output.

7. The information processing method according to claim 4, further comprising:
obtaining operating performance data representing operating statuses of the equipment and work performance data representing work times of the workers; and
estimating, based on the operating performance data and the work performance data, operating time distributions for each unit of the equipment and work time distributions for each of the workers, wherein
in the estimating of the equipment operating rate, the equipment operating rate is estimated for each item of the worker assignment data and for each of the workers, using the operating time distributions and the work time distributions.

8. An information processing device comprising:
an obtainer that obtains items of priority data each representing a priority for a combination of a unit of equipment among units of equipment and a stoppage factor, the priority being for recovery work for equipment that has stopped among the units of equipment;
an estimator that estimates, for each item of the priority data, an equipment operating rate of overseen equipment among the units of equipment, the overseen equipment being equipment that a worker who performs the recovery work is in charge of;
a selector that selects, from among the items of priority data, priority data for which the equipment operating rate is greater than or equal to a threshold value; and
an outputter that outputs the priority data selected.
